(19) United States
(12) Patent Application Publication
(10) Pub. No.: US 2006/0132966 A1
(43) Pub. Date: Jun. 22, 2006

(54) Connection of circuit board with housing of disk drive

(75) Inventors: Kohji Serizawa, Kanagawa (JP); Hitoshi Tsujino, Kanagawa (JP); Takashi Tomita, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., AZ Amsterdam (NL)

(21) Appl. No.: 11/295,388

(22) Filed: Dec. 5, 2005

(30) Foreign Application Priority Data
Dec. 22, 2004 (JP) 2004-371238

(51) Int. Cl. G11B 17/00

(52) U.S. Cl. 360/97.01

(57) ABSTRACT

Oscillation of a spindle motor caused by a shock is to be suppressed. In one embodiment, an HDD according to an embodiment of the present invention comprises a base, a spindle motor for rotating a magnetic disk, the spindle motor being fixed to an inner surface of a base bottom, and a circuit board disposed on an outer surface of the base bottom. Plural outer screws fix the circuit board to the base bottom at outer end portions of the circuit board. Further, three or more inner screws fix the circuit board to the base bottom at inner positions of the circuit board with respect to the outer screws. The center of gravity of the spindle motor is positioned within a polygon defined by the three or more inner screws.

### CROSS-REFERENCES TO RELATED APPLICATIONS

This application claims priority from Japanese Patent Application No. JP2004-371238, filed Dec. 22, 2004, the entire disclosure of which is incorporated herein by reference.

### BACKGROUND OF THE INVENTION

The present invention relates to a disk drive. Particularly, the present invention is concerned with fixing between an enclosure of a magnetic disk and a circuit board disposed outside the enclosure.

Data storage devices using various types of media such as optical disks and magnetic tapes are known. Among them, hard disk drives (hereinafter referred to as HDDs) have become popular as storage devices for computers to such an extent that they are one type of storage devices indispensable for today's computers. Further, not limited to computer systems, HDDs are expanding more and more in application because of its excellent characteristics. For example, HDDs are used for moving picture recording/reproducing devices, car navigation systems, cellular phones, and removable memories for use in digital cameras.

Each magnetic disk used in HDDs has a plurality of tracks formed concentrically and each track is partitioned into a plurality of sectors. Servo data address information and user data are stored in each of the sectors. The spindle motor rotates the magnetic disk and a head as a thin film element makes access to a desired address position in accordance with servo data stored in a sector, whereby it is possible to effect write or read of data to or from the magnetic disk.

The head is fixed to a slider. The slider is adapted to fly over a rotating magnetic disk, whereby the head or the head element can be moved to a desired position over the magnetic disk. In a data read operation, a signal read from the magnetic disk by the head is subjected to predetermined signal processing such as waveform shaping or decoding in a signal processing circuit and is then sent to a host. Likewise, data transferred from the host is subjected to predetermined signal processing in the signal processing circuit and is then written to the magnetic disk.

In HDD, not only oscillation caused by rotation of the magnetic disk poses a problem (see, for example, Patent Document 1 (Japanese Patent Laid-Open No. Hei 10(1998)-320964)), but also a satisfactory impact resistance to collision with an external object is required. As mentioned above, since HDD is mounted in various products, it is required to exhibit an impact-resisting performance corresponding to the product in which it is mounted. Particularly, when mounted in a portable product such as a note-size PC or a digital camera, HDD is required to possess a high impact resistance. In the actual manufacture of products, HDD or an HDD-mounted product is dropped onto a floor surface to check the impact-resisting performance of the HDD.

On the other hand, downsizing of the slider is being promoted from the standpoint of reducing the size of HDD, increasing the surface recording density, reducing the cost and improving the seek speed. The slider size is defined by IDEMA (International Disk Drive Equipment and Materials Association) Standard. More particularly, in order of size, mini slider, micro slider, nano slider, pico slider, and femto slider, are defined as slider sizes. Although pico slider is most popular in the existing HDDs, it is presumed that femto slider will be used in a larger number of HDDs in future.

### BRIEF SUMMARY OF THE INVENTION

Having studied the impact resistance of HDD using a femto slider, the present inventors found out that there occurred a hard error not recognized in the conventional pico slider. More particularly, a magnetic disk was found to be flawed by a drop impact. As a result of extensive studies it turned out that there occurred oscillation of a spindle motor by collision of HDD with a floor surface and that a magnetic disk was flawed by collision of a slider with the magnetic disk. Since the flying height of the femto slider is small, it is presumed that the problem caused by collision of the slider with the magnetic disk, which is attributable to an external shock, has been actualized.

The present invention has been accomplished with the above-mentioned circumstances as background and it is a feature of the invention to improve the impact-resisting performance of a magnetic disk drive.

Having made extensive studies concerning the above-mentioned problem, the present inventors found out that the impact-resisting performance of the disk drive could be improved and the occurrence of a hard error caused by an external shock could be suppressed by appropriately designing a fixing method for fixing between a base bottom to which a motor is fixed and a circuit board disposed on an outer side face of the base bottom.

In one aspect of the present invention there is provided a disk drive comprising a base, a motor for rotating a recording disk, the motor being fixed to an inner surface of a bottom of the base, a circuit board disposed on an outer surface of the bottom of the base, a plurality of outer fixing mechanisms for fixing the circuit board to the outer surface of the bottom of the base at outer end portions of the circuit board, and three or more inner fixing mechanisms for fixing the circuit board to the outer surface of the bottom of the base at inner positions of the circuit board with respect to the outer fixing mechanisms, the center of gravity of the motor being positioned within a polygon defined by the three or more inner fixing mechanisms. With this layout of the fixing means, it is possible for the circuit board to suppress oscillation of the base bottom effectively and hence possible improve the impact-resisting performance of the disk drive.

It is preferable that an acoustic foam be held grippingly between the circuit board and the base bottom. With the acoustic foam, it is possible to reduce the noise of the disk drive and enhance the effect of suppressing oscillation of the base bottom. Further, it is preferable that the thickness of the acoustic foam be 1.5 mm or more. The above layout of the fixing mechanisms permits the use of such a thickness of an acoustic foam and thereby permits a great improvement of the noise reducing effect.

From the standpoint of manufacture and re-work it is preferable that the fixing mechanisms be screws. It is preferable that the three or more inner fixing mechanisms fix the circuit board to the outer surface of the base bottom in the vicinity of the motor. With this layout, the circuit board can absorb oscillation of the base bottom effectively. From the standpoint of absorbing oscillation of the base bottom and mounting of the circuit board, it is preferable that the number of the inner fixing mechanisms for fixing the circuit board to the outer surface of the base bottom be four.

The present invention is particularly effective as the disk drive wherein the recording disk is a magnetic disk and which further comprises a femto slider with a magnetic thin film head fixed thereto and an actuator for moving the femto slider over the recording disk. Or the present invention is particularly effective as the disk drive wherein a plurality of recording disks are mounted on the motor.

In another aspect of the present invention there is provided a magnetic disk drive comprising a base, a spindle motor fixed to an inner surface of a bottom of the base, a plurality of magnetic disks fixed to and rotated by the spindle motor, a plurality of head slider assemblies each comprising a magnetic thin head which performs read and write of data between it and the magnetic disk associated therewith and a femto slider to which the magnetic thin film is fixed, an actuator for moving the plural head slider assemblies over the plural magnetic disks, a circuit board disposed on an outer surface of the bottom of the base and centrally provided with a hole for fitting therein of a convex portion of the base which convex portion corresponds to the spindle motor, three or more outer screws for fixing the circuit board to the bottom of the base at outer end portions of the circuit board, and three or more inner screws for fixing the circuit board to the bottom of the base at inner positions of the circuit board with respect to the three or more outer screws, wherein the three or more inner screws are disposed adjacent the hole and the center of gravity of the spindle motor is positioned within a polygon defined by the three or more inner screws.

According to the present invention it is possible to improve the impact-resisting performance of a magnetic disk drive.

### BRIEF DESCRIPTION OF THE DRAWINGS

FIG. 1 is an exploded perspective view showing the construction of an HDD according to an embodiment of the present invention.

FIG. 2 is a plan view showing schematically an internal construction of an HDD body used in the embodiment.

FIG. 3 is a perspective view showing the construction of a circuit board used in the embodiment.

FIG. 4 is a plan view of the HDD as seen from the circuit board side.

FIG. 5 is a sectional view taken on line V-V in FIG. 4, showing a partial construction of the HDD.

FIG. 6 is a diagram schematically showing oscillation in a primary oscillation mode of a base bottom 111a used in the embodiment.

FIG. 7 is a diagram showing a positional relation between a point resulting from projection of the center of gravity G of a spindle motor used in the embodiment in a direction perpendicular to the circuit board and inner screws.

FIG. 8 is a graph of measurement data showing a relation between the layout of inner screws and oscillation frequency of the base bottom.

FIG. 9 is a graph of actual measurement data showing a relation between the thickness of an acoustic foam and noise.

### DETAILED DESCRIPTION OF THE INVENTION

An embodiment to which the present invention is applicable will be described hereinunder. In the following description and the drawings, omissions and simplifications are made as necessary for making explanations clear. In the drawings, the same elements are identified by the same reference numerals, and tautological explanations are omitted as necessary for making explanations clear.

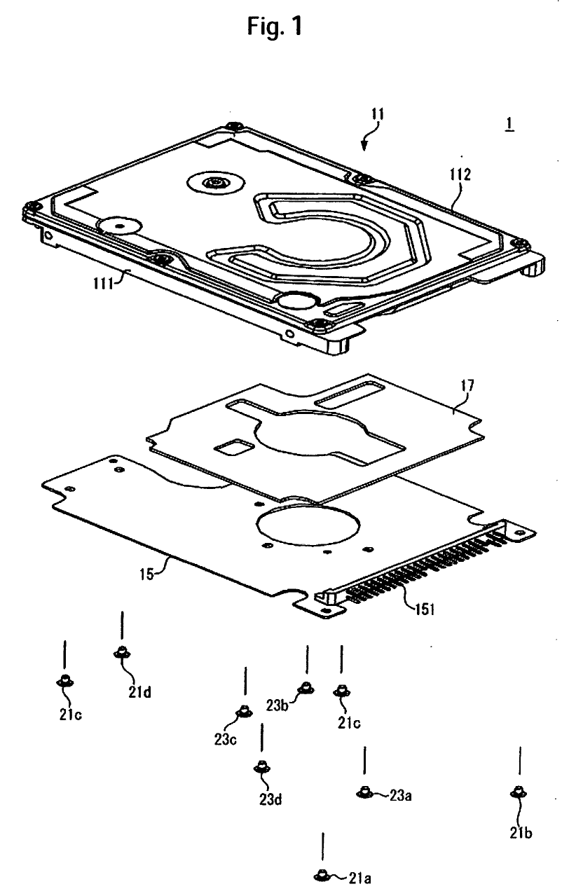

FIG. 1 is an exploded perspective view showing the construction of an HDD (Hard Disk Drive) 1 as an example of a disk drive according to an embodiment of the present invention. The HDD 1 includes an HDD body 11 and a circuit board 15 mounted on the HDD body 11. An acoustic foam 17 for suppressing the oscillation noise is held grippingly between the HDD body 11 and the circuit board 15.

The HDD body 11 accommodates various components within an enclosure composed of a base 111 and a top cover 112. The base 111 accommodates various components of the HDD 11 and is fixed through a gasket (not shown) to the top cover 112 which closes an upper opening of the base 111. In this way the components of the HDD body 11 can be accommodated in a hermetically sealed state. The base 111 and the top cover 112 are typically formed of aluminum or stainless steel.

The circuit board 15 is fixed to the base 111 side of the HDD body 11. Typically, the circuit board 15 is formed of resin such as epoxy resin. The base 111 and the circuit board 15 are fixed together using plural screws. In the example shown in FIG. 1, nine screws 21a to 21e and 23a to 23d are used for fixing the circuit board 15 and the HDD body 11 with each other. The screws respectively pass through through-holes formed in the circuit board 15 and are threadedly engaged with screw holes formed in an outer surface of the HDD body 11. In the HDD 1 of this embodiment, the HDD body 11 and the circuit board 15 are fixed together using plural screws disposed at predetermined positions. By appropriately designing the layout and number of the screws it is possible to improve the impact-resisting performance of the HDD 1 and effectively suppress the occurrence of a hard error caused by an external shock. As to the layout of screws in this embodiment, a detailed description will be given later.

A connector 151 is mounted on the circuit board 15. The connector 151 is fixed to one side of the circuit board 15. FIG. 1 shows a connector of Parallel ATA as an example. A connector of another protocol such as Serial ATA may be mounted in accordance with design. On the circuit board 15 are mounted various circuit elements (not shown) such as ICs for controlling the HDD body 11 and controlling data communication between a host (not shown) and the HDD 1. For example, various ICs, including HDC (Hard Disk Controller)/MPC, read/write channels and motor driver, are mounted on the surface on the HDD body 11 side (base 111 side) of the circuit board 15 together with such elements as resistors.

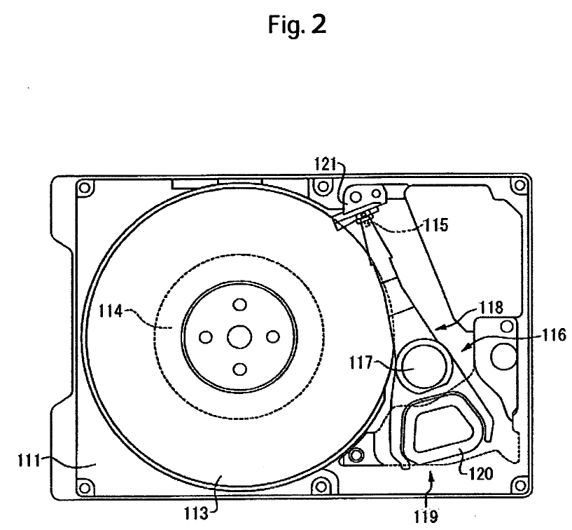

Before explaining how to fix the circuit board 15 and the base 111 to each other, a description will be given about the HDD body 11. FIG. 2 is a plan view schematically showing an internal construction of the HDD body 11. The connector 151 fixed to the circuit board 15 is disposed on the left side in FIG. 2. As shown in the same figure, a magnetic disk 113 is disposed within the base 111. The magnetic disk 113 is a non-volatile recording medium which records data by magnetization of a magnetic layer. The magnetic disk 113 is fixed to the spindle motor 114, which in turn rotates the magnetic disk 113 at a predetermined speed. The HDD body 11 is provided with one or a plurality of stacked magnetic disks 113. Typically, data are stored on both surfaces of each magnetic disk 113. Plural head slider assemblies 115 corresponding respectively to recording surfaces of the magnetic disks 113 are held by an actuator 116.

Each head slider assembly 115 comprises a head and a slider with the head fixed to a surface thereof. In the head slider assemblies 115 used in this embodiment, femto sliders are used. The head writes and/or reads data to and/or from the associated magnetic disk 113 which data are inputted and outputted between the head and a host. The head includes a write element which converts an electric signal into a magnetic field in accordance with data to be stored to the magnetic disk 113 and/or a read element which converts a magnetic field provided from the magnetic disk 113 into an electric signal.

The actuator 116 is held pivotably by a pivot shaft 117 and includes a carriage 118 and a VCM (Voice Coil Motor) 119. A part of the VCM 119 is cut out for convenience' sake and the profile thereof is indicated by a broken line. In accordance with a drive signal fed from a circuit on the circuit board 15 to a flat coil 120, the VCM 119 causes the actuator 116 to move pivotally about the pivot shaft 117 and thereby causes the head slider assembly 115 concerned to move over the magnetic disk 113 which is rotating.

As the actuator 116 causes the head slider assembly 115 to move radially of a surface of the magnetic disk 113, the head slider assembly 115 can access a desired track. In a balanced state between pressure induced by the viscosity of air present between an ABS (Air Bearing Surface) of the slider opposed to the magnetic disk 113 and the magnetic disk 113 which is rotating, the head slider assembly 115 flies over the magnetic disk 13 through a certain gap.

When the rotation of the magnetic disk 113 stops, the actuator 116 unloads the head slider assembly 115 to a ramp mechanism 121 from above the magnetic disk 113. There also is known a CSS (Contact Start and Stop) method wherein the head retracts to a zone formed on the inner periphery side of the magnetic disk 113 when the head performs neither write nor read of data.

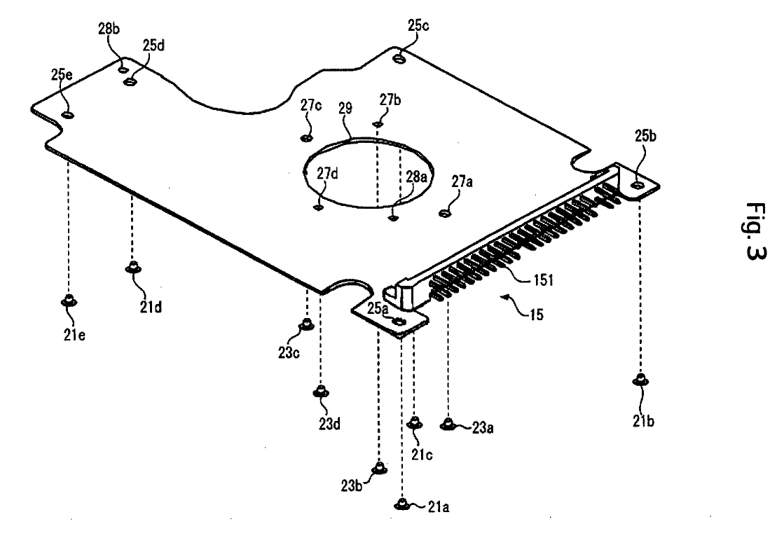

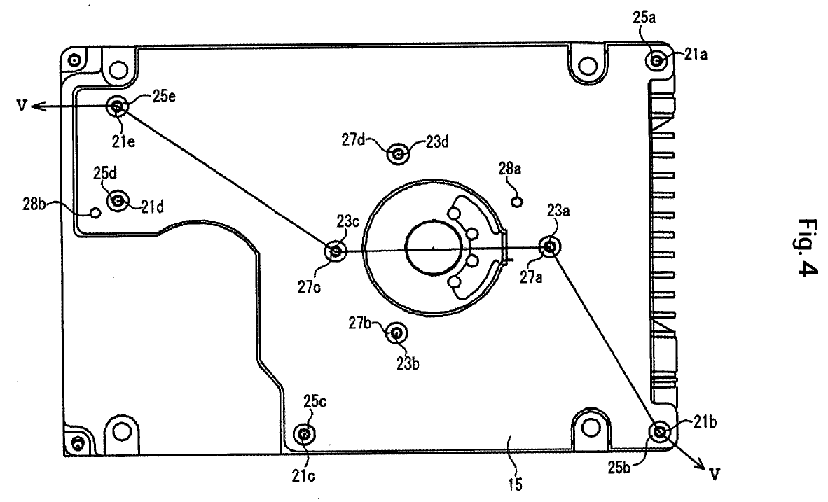

With reference to FIGS. 3 and 4, a description will now be given about a method for fixing the circuit board 15 to the base 111. FIG. 3 is a perspective view showing the construction of the circuit board 15 and FIG. 4 is a plan view of the HDD 1 as seen from the circuit board 15 side. In FIG. 3, an upper surface is opposed to the base 111 and on which circuit elements are mounted. As shown in FIG. 3, nine screw holes 25a to 25e and 27a to 27d and two positioning holes 28a and 28b are formed in the circuit board 15. In an inner central portion of the circuit board 15 is formed a hole 29 for fitting therein of a convex portion of the base 111 corresponding to a spindle motor 104. Lugs formed on an outer surface of a bottom of the base 111 are fitted in the positioning holes 28a and 28b to locate the circuit board 15 at a predetermined position of the HDD 1 (base 111).

The screw holes 25a to 25e and 27a to 27d are typically not tapped, but mere through holes. Five screw holes 25a to 25e (hereinafter referred to as “outer screw holes 25”) are formed in end portions of the circuit board 15. The outer screw holes 25 are formed respectively in corner portions of the circuit board 15. By forming the outer screw holes 25 in positions near end sides of the circuit board 15, it is possible to fix the circuit board 15 firmly to the base 111. Further, four screw holes 27a to 27d (“inner screw holes” hereinafter) are formed in inner positions of the circuit board 15. The inner holes for screw 27 formed in inner positions with respect to the outer screw holes 25 are formed so as to surround the hole 29.

As shown in FIG. 4, the screws 21a to 21e (“outer screws 21” hereinafter) inserted respectively through the outer screw holes 25 formed in the circuit board 15 and the screws 23a to 23d (“inner screws 23” hereinafter) inserted respectively through the inner screw holes 27 fix the circuit board 15 to the outer surface of the bottom of the base 111. The inner screws 23 are arranged so as to surround a rotary shaft of the spindle motor 114 in the vicinity of the spindle motor 114. The center of gravity of the spindle motor 114 lies on the axis of the rotary shaft. Therefore, a point resulting from projection of the center of gravity of the spindle motor 104 perpendicularly to the circuit board 15 lies within a quadrangular shape defined by the inner screws 23.

Thus, with the four inner screws 23 which are arranged so that the center of gravity of the spindle motor 114 lies within the aforesaid quadrangular shape and with the outer screws 21 arranged outside the inner screws 23, it is possible to effectively suppress oscillation of the spindle motor 104 and that of the magnetic disk 113 fixed thereto, whereby the collision between the head slider assembly 115 and the magnetic disk 113, which is caused by an external shock, can be prevented more positively and it is possible to prevent the occurrence of a hard error.

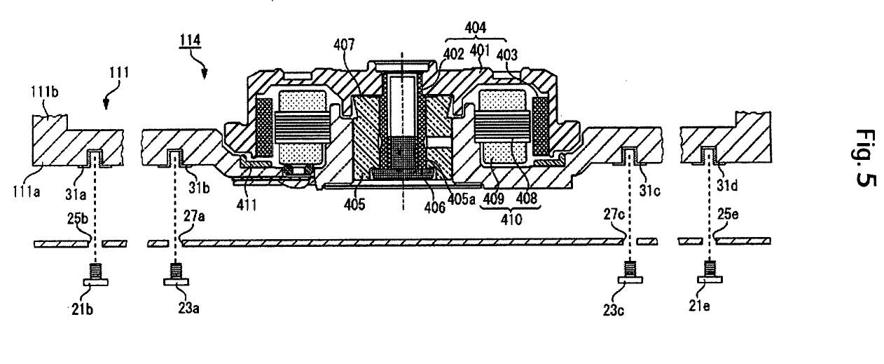

The following description is now provided about the operation of the fixing with screws between the base 111 and the circuit board 15 in this embodiment. FIG. 5 is a sectional view showing a partial construction of the HDD 1 in a section taken on line V-V in FIG. 4. In FIG. 5, the construction is partially omitted with respect to the magnetic disk 113, etc. The center of the rotary shaft of the spindle motor 114 is indicated by a dotted line and the center of gravity of the spindle motor 114 lies on the dotted line. The base 111 includes a base bottom 111a and side walls 111b erected at ends of the base bottom 111a. The spindle motor 114 is disposed in a concave portion formed in an inner surface of the base bottom 111a. As an example of the spindle motor 114 there is provided a fluid bearing motor using oil in a bearing portion. The application of the circuit board 15 and base 111 fixing method adopted in this embodiment is not limited to the HDD having a fluid bearing motor.

In FIG. 5, the spindle motor 114 has a shaft rotation structure with a rotary shaft (shaft 402 ) fixed to a rotating hub 401. The magnetic disk 113 is fixed to an outer periphery of the hub 401. The rotary shaft 402 is fixed to a central part on an inner surface side of the hub 401. The numeral 403 denotes a rotor magnet, which is fixed to an inner surface of a side portion of the hub 401. An integrally constructed rotor section 404 is formed by the hub 401, shaft 402 and rotor magnet 403. Numeral 405 denotes a sleeve for receiving the shaft 402 therein.

A bearing hole 405a for receiving the shaft 402 therein is formed in the sleeve 405. The shaft 402 is received in the bearing hole 405a rotatably. Oil is applied between the shaft 402 and an inner surface of the bearing hole 405a, serving as a radial bearing portion 406. Likewise, oil is applied between an upper surface of the sleeve 405 and an inner surface of the hub 401, serving as a thrust bearing portion 407.

A stator coil 409 is wound round a stator core 408. An integrally constructed stator portion 410 is formed by the stator coil 409 and the stator core 408. When the stator coil 409 is energized, torque is developed by a rotating magnetic field which is induced by the stator portion 410, so that the rotor portion 404 begins rotating. With rotation of the rotor portion 404, pressure is developed in the radial bearing portion 406. Pressure is also developed in the thrust bearing portion 407 and the hub 401 flies from the upper surface of the sleeve 405, whereby the rotor portion 404 can rotate in a non-contact condition.

In order to form a magnetic back pressure which balances with the flying force of the rotor portion 404, a bias plate 411 formed of a magnetic material is fixed to the inside bottom (the inner surface of the base bottom 111a) of the base 111. A magnetic back pressure between the rotor magnet 403 and the bias plate 411 attracts the rotor portion 404 to the base 111 against the flying force induced by the thrust bearing portion 407 to control rotation of the rotor portion 404.

The outer screws 21 and the inner screws 23 respectively pass through the outer screw holes 25 and the inner screw holes 27 formed in the circuit board 15 and are threadedly engaged with tapped holes formed in the base 111 and having tapped inner surfaces. Screw sockets 31a to 31d formed as separate parts from the base 111 and having threaded inner surfaces are embedded in an outer surface of the base bottom 111a. The base 111 itself may be threaded.

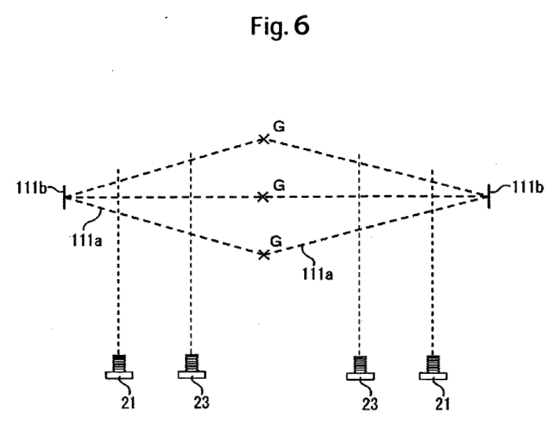

The inner screws 23 fix the circuit board 15 to the base bottom 111a in the vicinity of the spindle motor 114 and outside the hub 401. No fixing screw is present inside the inner screws 23. Further, the outer screws 21 fix the circuit board 15 to the base bottom 111a outside the inner screws 23 and at end portions of the circuit board 15 and base bottom 111a. Reference will now be made to oscillation of the base bottom 111a. FIG. 6 schematically shows oscillation of the base bottom 111a. It is a primary oscillation mode of the base bottom 111a that is shown in FIG. 6. It can be considered that the base bottom 111a oscillates with side walls 111b as fixed ends. Moreover, since the spindle motor 114 is fixed to the inner surface of the base bottom 111a, it can be considered that the center of gravity G of the spindle motor 114 coincides with the loop of the primary oscillation mode of the base bottom 111a.

The base bottom 111a oscillates at a largest amplitude in the primary oscillation mode. As a result, the spindle motor 114 fixed to the base bottom 111a and the magnetic disk 113 fixed to the spindle motor 114 largely oscillate vertically. If the amplitude of this oscillation is large, the magnetic disk 113 collides with the head slider assembly 115, causing a hard error such as the magnetic disk 113 being flawed. This problem is conspicuous particularly in HDD which uses a femto slider of a small flying height. As the number and weight of magnetic disks 113 increase, the oscillation amplitude of the base bottom 111a increases. Thus, in HDD 1 with plural magnetic disks 113 mounted thereon, the oscillation of the base bottom 111a poses a serious problem.

Since the circuit board 15 is formed of resin and has elasticity, it can function as a damping material against oscillation of the base bottom 111a. However, in the case where the circuit board 15 is fixed to the base bottom 111a with only the outer screws 21 and is not fixed to the inside of the base bottom 111a, the circuit board 15 cannot absorb the oscillation of the base bottom 111a and hence it is impossible to suppress the primary mode oscillation of the base bottom.

By fixing the base bottom 111a and the circuit board 15 inside the outer screws 21, it is possible to expect a damping effect of the circuit board 15. However, for fully suppressing the primary oscillation mode of the base bottom 111a, it is considered necessary to make an appropriate design for the number and layout of screws. The oscillation of the base bottom 111a is a surface oscillation, i.e., a two-dimensional oscillation. Therefore, for suppressing oscillation of the base bottom 111a it is necessary that the base bottom 111a and the circuit board 15 be fixed surface to surface. That is, it is necessary to fix the two with use of at least three inner screws 23.

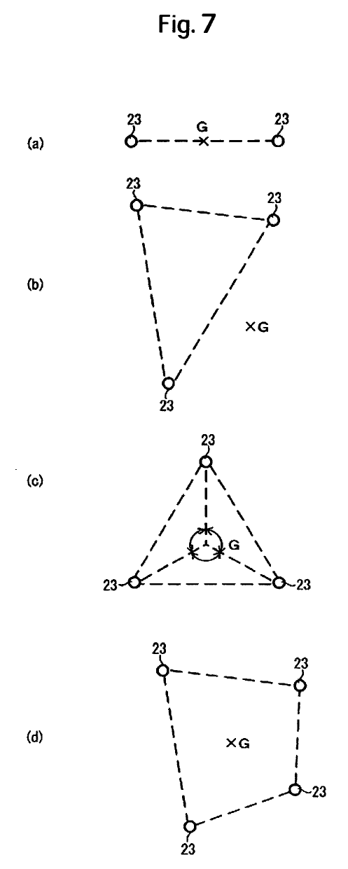

Further, as noted above, the base bottom 111a oscillates in the primary oscillation mode with the center of gravity G of the spindle motor 114 as the loop. Therefore, for suppressing the primary oscillation mode of the base bottom 111a with as small a number of screws as possible, it is necessary that the center of gravity of the spindle motor 114 be positioned within a polygon defined by the inner screws 23. FIG. 7 shows a positional relation between a point resulting from projection of the center of gravity G of the spindle motor 14 in a direction perpendicular to the circuit board 15 and the inner screws 23. As shown in FIG. 7(a), when the two are fixed together at two inner points, it is impossible to fully suppress the two-dimensional oscillation of the base bottom 111a. Likewise, as shown in FIG. 7(b), even if the two are fixed together at three points, it is impossible to let the circuit board 15 exhibit a satisfactory damping effect because the center of gravity G of the spindle motor 114 is outside the polygon defined by the fixing points.

On the other hand, according to the layout of inner screws 23 shown in FIGS. 7(c) and 7(d), it is possible to effectively suppress the amplitude in the primary oscillation mode of the base bottom 111a. In FIG. 7(c), three inner screws 23 fix the circuit board 15 and the base bottom 111a to each other and the center of gravity G of the spindle motor 114 is positioned within a triangle (polygon) defined by the three inner screws 23. Consequently, the primary mode oscillation of the base bottom 111a can be suppressed effectively by the three inner screws 23. Likewise, in FIG. 7(d), the center of gravity G of the spindle motor 114 is positioned within a square (polygon) defined by four inner screws 23.

Thus, the circuit board 15 and the base bottom 111a are fixed together using plural, three or more, inner screws 23. Further, by disposing the inner screws 23 so that the center of gravity G of the spindle motor 114 is positioned within a polygon defined by the inner screws 23, the amplitude of oscillation of the base bottom 111a can be suppressed effectively even by use of such a small number of screws. From the standpoint of suppressing the oscillation, it is preferable that the number of inner screws used be large. However, since an increase in the number of screws means a decrease in the packaging area of the circuit board 15, it is preferable that the circuit board 15 be fixed to the base bottom 111a with four inner screws 23.

As seen from the above description, it is important that the plural inner screws 23 be each disposed in the vicinity of the spindle motor 114. If the inner screws 23 are largely spaced from the centroid position of the spindle motor 114, the circuit board 15 cannot absorb oscillation at the portion where the oscillation amplitude of the base bottom 111a is large, and it may be impossible for the circuit board to exhibit a satisfactory damping effect. For suppressing the two-dimensional oscillation effectively, it is preferable that the inner screws 23 be arranged at an angle as equal or uniform as possible in a circumferential direction centered on the center of gravity of the spindle motor 114.

Obviously, for allowing the circuit board 15 to exhibit its damping performance, it is necessary to use outer screws 21 in addition to the inner screws 23. Without the outer screws 21, the circuit board 15 moves vertically with oscillation of the base bottom 111a and cannot exhibit its damping effect. For fixing the circuit board 15 efficiently with use of a smaller number of screws, it is preferable that at least three outer screws 21 be arranged spacedly at end portions of the circuit board 15.

For example, it is preferable that three outer screws 21 be arranged at three different end sides respectively or, as shown in FIG. 4, outer screws 21 be arranged at different corners of the circuit board 15. Further, since a strong external force is apt to be exerted on the connector 151, it is preferable to arrange outer screws 21 respectively on both sides of the connector 151. For fixing the circuit board and the base bottom it is preferable to use a large number of outer screws, but since an increase in the number of screws used leads to a decrease in the packaging area of the circuit board 15, outer screws are used in a number falling under a required range.

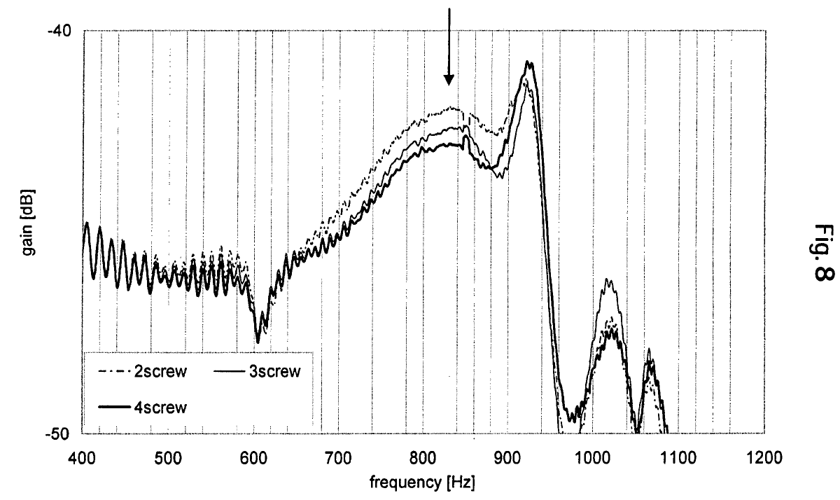

An HDD according to this embodiment was actually fabricated and checked for the effect of the embodiment. Oscillation frequency of the base bottom was measured using a shaking machine. The HDD fabricated was set to the shaking machine and was oscillated in the z direction (the rotary shaft direction of the spindle motor) while changing the oscillation frequency of the shaking machine. FIG. 8 is a graph showing the results of the measurement. The number of inner screws used changed in the measurement. FIG. 8 shows oscillations with respect to each of the number of inner screws being two, three, and four. In cases where the number of inner screws is three and four, the inner screws were arranged so that the center of gravity of the spindle motor was positioned within each of the polygons defined by them. Outer screws were arranged as in FIG. 4.

In FIG. 8, oscillation frequency and amplitude of the base bottom are plotted along X and Y axes, respectively. In the HDD used in the measurement, the frequency in the primary oscillation mode of the base bottom was approximately 830 Hz. As shown in the same figure, with an increase in the number of inner screws from two to three, the amplitude in the primary oscillation mode lowered to a great extent. A further improvement was observed when the number of inner screws was increased to four.

The HDD 1 of this embodiment has the acoustic foam 17 held grippingly between the circuit board 15 and the base 111. Even when the circuit board 15 is fixed directly to the base 111, the circuit board 15 exhibits its damping effect. However, since the acoustic foam 17 not only exhibits an oscillation noise deadening effect for the HDD 1 but also enhances the damping effect of the circuit board 15, it is preferable that the acoustic foam 17 be disposed between the circuit board 15 and the base 111. Preferably, the acoustic foam 17 is a polyurethane foam.

For enhancing the noise deadening effect of the acoustic foam 17 it is preferable that the acoustic foam be thick. However, in case of using a thick acoustic foam 17, there arises the problem that the circuit board 15 is deflected (expanded) outwards by the acoustic foam 17, making it impossible to mount the HDD 1 on a host. The HDD 1 of this embodiment is provided with three or more inner screws 23 in the vicinity of the spindle motor 114 in addition to the outer screws 21. Therefore, even when using a thick acoustic foam 17, it is possible to fix the circuit board 15 firmly to the base 111 and thereby prevent deflection of the same board. For enhancing the noise deadening effect of the acoustic foam 17 it is preferable that the thickness of the acoustic foam be about 1.5 mm or more.

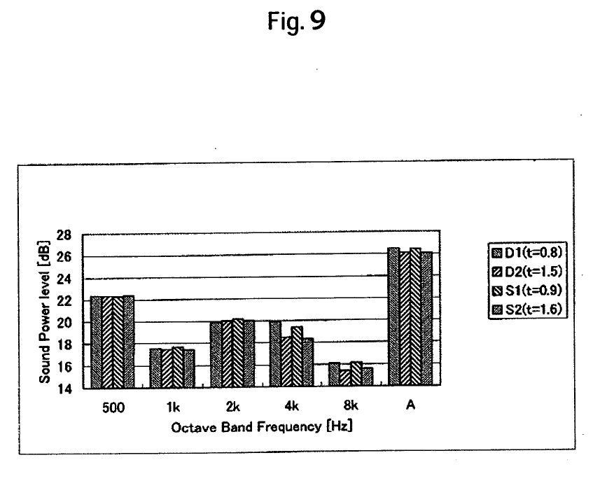

FIG. 9 is a graph of actual measurement data showing a relation between the thickness of the acoustic foam and noise. In FIG. 9, noise frequency and noise volume are plotted along the axis of abscissa and the axis of ordinate, respectively. In the same figure, D1, D2 and S1, S2 show different thicknesses of acoustic foams in the same HDD configuration. Acoustic foam thicknesses of D1, D2, S1, and S2, were 0.8 mm, 1.5 mm, 0.9 mm, and 1.6 mm, respectively. The graphs indicated at A show values obtained by multiplying various frequencies by weighting factors based on the human auditory sense and by subsequent addition.

More specifically, the value of A was calculated in accordance with the following expression:
Aw[dB]:=10*Log(Σ10ˆ((Lw i+ai)/10)))

TABLE 1

| | Band [Hz] | | | | | | |
|---|---|---|---|---|---|---|---|
| | 125 | 250 | 500 | 1000 | 2000 | 4000 | 8000 |
| ai [dB] | −16.1 | −8.6 | −3.2 | 0.0 | 1.2 | 1.0 | −1.1 |

Here, Lwi denotes measurement value and ai denotes weighting factor.

As seen from the drawing, a significant lowering of noise by a level of 0.5 dB was recognized by increasing the acoustic foam thickness.

The above description is for explaining the embodiment of the present invention. It is not that the invention is limited to the above embodiment. Any person skilled in the art can make changes, additions and conversions of the elements described in the above embodiment easily within the scope of the present invention. For example, from the standpoint of rework it is preferable to use screws as fixing means, but other fixing means than screws, e.g., rivets, are also employable. Further, the present invention is also applicable to other disk drives than HDD.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims along with their full scope of equivalents.

What is claimed is:

1. A disk drive comprising:
a base;
a motor configured to rotate a recording disk, said motor being fixed to an inner surface of a bottom of said base;
a circuit board disposed on an outer surface of the bottom of said base;
a plurality of outer attaching members configured to attach said circuit board to the outer surface of the bottom of said base at outer end portions of the circuit board; and
three or more inner attaching members configured to attach said circuit board to the outer surface of the bottom of said base at inner positions of the circuit board with respect to said outer attaching members, the center of gravity of said motor being positioned within a polygon defined by said three or more inner attaching members.

2. A disk drive according to claim 1, wherein an acoustic foam is held grippingly between said circuit board and the bottom of said base.

3. A disk drive according to claim 2, wherein the thickness of said acoustic foam is about 1.5 mm or more.

4. A disk drive according to claim 2, wherein said acoustic foam comprises polyurethane.

5. A disk drive according to claim 1, wherein said inner and outer attaching members comprise screws.

6. A disk drive according to claim 1, wherein said three or more inner attaching members attach said circuit board to the outer surface of the bottom of said base in the vicinity of said motor.

7. A disk drive according to claim 6, wherein the number of said inner attaching members configured to attach said circuit board to the outer surface of the bottom of said base is four.

8. A disk drive according to claim 1, wherein said recording disk is a magnetic disk and which further comprises a femto slider with a magnetic thin film head fixed thereto and an actuator for moving said femto slider over said recording disk.

9. A disk drive according to claim 1, wherein a plurality of recording disks are mounted on said motor.

10. A magnetic disk drive comprising:
a base;
a spindle motor fixed to an inner surface of a bottom of said base;
a plurality of magnetic disks fixed to and rotated by said spindle motor;
a plurality of head slider assemblies each comprising a magnetic thin film head which performs read and write of data between it and said magnetic disk associated therewith and a femto slider to which said magnetic thin film head is fixed;
an actuator configured to move said plural head slider assemblies over said plural magnetic disks;
a circuit board disposed on an outer surface of the bottom of said base and centrally provided with a hole for fitting therein of a convex portion of said base which convex portion corresponds to said spindle motor;
three or more outer screws for attaching said circuit board to the bottom of said base at outer end portions of the circuit board; and
three or more inner screws for attaching said circuit board to the bottom of said base at inner positions of the circuit board with respect to said three or more outer screws,
wherein said three or more inner screws are disposed adjacent said hole and the center of gravity of said spindle motor is positioned within a polygon defined by said three or more inner screws.

11. A magnetic disk drive according to claim 10, wherein an acoustic foam is held grippingly between said circuit board and the bottom of said base.

12. A magnetic disk drive according to claim 11, wherein the thickness of said acoustic foam is about 1.5 mm or more.

13. A magnetic disk drive according to claim 11, wherein said acoustic foam comprises polyurethane.

14. A magnetic disk drive according to claim 10, wherein the number of said inner screws is four.

15. A disk drive comprising:
a base;
a motor for rotating a recording disk, said motor being fixed to an inner surface of a bottom of said base;
a circuit board disposed on an outer surface of the bottom of said base;
outer fixing means for fixing said circuit board to the outer surface of the bottom of said base at outer end portions of the circuit board; and
inner fixing means for fixing said circuit board to the outer surface of the bottom of said base at inner positions of the circuit board with respect to said outer fixing means, the center of gravity of said motor being positioned within a polygon defined by fixing locations of said inner fixing means.

16. A disk drive according to claim 15, wherein an acoustic foam is held grippingly between said circuit board and the bottom of said base.

17. A disk drive according to claim 16, wherein the thickness of said acoustic foam is 1.5 mm or more.

18. A disk drive according to claim 15, wherein said inner fixing means fix said circuit board to the outer surface of the bottom of said base in the vicinity of said motor.

19. A disk drive according to claim 15, wherein said recording disk is a magnetic disk and which further comprises a femto slider with a magnetic thin film head fixed thereto and an actuator for moving said femto slider over said recording disk.

20. A disk drive according to claim 15, wherein a plurality of recording disks are mounted on said motor.
